(19) United States
(12) Patent Application Publication
(10) Pub. No.: US 2021/0127759 A1
(43) Pub. Date: May 6, 2021

(54) UNDERPANTS

(71) Applicant: Christian GOZZI, Verona (IT)

(72) Inventors: Christian GOZZI, Verona (IT); Margit MAYER, Munchen (DE)

(73) Assignee: Christian GOZZI, Verona (IT)

(21) Appl. No.: 16/962,952

(22) PCT Filed: Dec. 14, 2018
(86) PCT No.: PCT/EP2018/084997

§ 371 Date: Jul. 17, 2020

(30) Foreign Application Priority Data
Jan. 24, 2018 (DE) 10 2018 101 549.6

(51) Int. Cl. A41B 9/00; A41B 9/14

(52) U.S. Cl. CPC A41B 9/004; A41B 9/14; A41F 9/025; A41B 2500/10; A41B 2500/20; A41B 2400/32

(57) ABSTRACT

Underpants (10) having two leg openings (2, 3), which (2, 3) are separated from each other by an underpants web (4) of the underpants (10). The underpants are intended to reduce or eliminate urinary incontinence while a user is wearing the underpants (10) and that for this purpose the underpants (10) have, in the region of the underpants web (4), a pressure body (6) intended to apply pressure to the user in the perineal area.

### TECHNICAL FIELD

The invention relates to a pair of pants with two leg openings which are separated from one another by a crosspiece of the pants, wherein the pants are intended for alleviating or eliminating urinary incontinence while a user is wearing the pants.

### BACKGROUND

In many humans, men as well as women, the muscles and ligaments in the region of the urinary tract and in particular in the region of the pelvic floor become slack due to age or illness, on account of a connective tissue weakness or as a result of operations, which can be manifested in a troublesome manner by way of a sudden urge to urinate or else by way of more or less pronounced incontinence (so-called dysfunction of the pelvic floor).

The muscle building that can be achieved by regular pelvic floor training is frequently not sufficient to achieve sufficient tightening and strengthening of the slackened muscles and ligaments in the region of the pelvic floor. In order to remedy this situation, operations which provide a restitution of the pelvic floor including the muscles and ligaments in this region may be necessary, the aim being that urinary incontinence can be at least alleviated as a result. Operations, however, are associated firstly with high costs and secondly with considerable stresses and risks for the patient.

Previously known from WO 2014/044831 A1 is a pair of pants, in the form of support briefs, of the type mentioned at the beginning, by means of which the pelvic floor musculature of a male or female user is intended to be supported in such a manner that for example incontinence can be reduced or even minimized. For this purpose, in order to exert a raising action on the perineal area and the pelvic floor, the previously known pants are provided with a lifting mechanism, by means of which the crotch section is intended to be supported and raised. This lifting mechanism comprises at least one lifting band, which extends between the waistband and the crotch section. In one exemplary embodiment, illustrated in more detail in WO 2014/044831 A1, two elastic lifting bands are provided, a first lifting band of which extends diagonally outward between the crotch section and the elastic waistband, while a second lifting band extends diagonally outward between the crotch section and the elastic waistband. The first and second lifting bands define a substantially V-shaped lifting system at the front part of the briefs, in order to support the user's pelvic floor muscles, in combination with the waistband, by means of a suitable compressive force upwardly in the direction of the waist.

Since a pair of underpants worn beneath the previously known support pants could counteract the function of the support pants, the previously known support pants are provided to be worn directly on the skin. In order to also be able to use the previously known support pants with a sanitary napkin or the like, the perineal area of the support pants has provided in it an openable pouch in which the exchangeable sanitary napkin or else a cloth can be laid. The lifting mechanism integrated in the previously known support pants thus provides only one or several compression crosspieces which are integrated in the pants and bring about a supporting force upwardly in the direction of the waistband of the pants. By contrast, an application of pressure to the user in the perineal area by means of a pressure body is not provided. The previously known support pants are also not in the form of a woven fabric or knitted fabric produced using elastic fibers; rather, by contrast, the compression crosspieces are provided, and effective, in defined partial regions of the pants.

KR 2010 0004798 U already discloses a pair of pants for cyclists, by means of which the impacts, jolts and loads acting on the cyclist via the saddle during travel are intended to be able to be absorbed and, if required, transferred in a targeted manner to the cyclist's bones. For this purpose, the previously known pants have an insert made from silicone which is provided on the inside of the pants, is adapted to the contour of the saddle and, in the region of the pelvic bones that bear down on the saddle, has resilient partial regions made from silicone which can diminish impacts and, if necessary, transfer said impacts to the pelvic bones in a targeted manner. Although the insert in the previously known pants is adapted to the form of a bicycle saddle, —an application of pressure to the user further away from the pelvic bones and in particular in the soft perineal area is specifically not provided in the case of the previously known pants.

DE 10 2008 034 496 A1 already discloses an insert for a pair of cyclist's pants which is intended to provide a raised ventilation surface with a low coefficient of friction. For this purpose, the previously known insert has various elastic layers, between which channels are provided. In order to facilitate ventilation of the cyclist's skin and in order to reduce friction on the skin, the previously known insert has protuberances which consist of upright, conical or cylindrical, volcano-shaped microcapsules made from elastomeric material. It is neither endeavoured nor possible to influence incontinence of the user by means of the previously known insert.

### SUMMARY

The object therefore consists in providing a pair of pants of the type mentioned at the beginning, by means of which stress for the patient as a result of a sudden urge to urinate or even urinary incontinence can be at least alleviated or even eliminated.

This object is achieved according to the invention in particular in that, in the case of the pants of the type mentioned at the beginning, in the region of the pants web, the pants have a pressure body which is intended for applying pressure to the user in the perineal area, is cam-shaped or approximately hemispherical at least in a partial region, and is produced from a hard, hard-elastic and/or inflexible material, in that the pants are in the form of a woven fabric or knitted fabric produced using elastic fibers, and in that the pressure body is connected immovably to the material of the pants.

The pants according to the invention have two leg openings which are separated from one another by a pants crosspiece, wherein the pants crosspiece has a pressure body intended for applying pressure to the patient or user in the perineal area. This pressure body provided on the crosspiece of the pants according to the invention presses onto the user's body in the perineal area. In order to be able to apply the highest possible compressive force to the user's body, the pressure body is cam-shaped or approximately hemispherical at least in a partial region. In order that the generated compressive force is transferred to the user's perineal area in a manner as undiminished as possible, the pressure body is produced from a hard, hard-elastic and/or inflexible material. The pressure exerted on the user's perineal area by means of the pressure body raises the user's muscles or ligaments slackened in this region and tightens the urinary tract in this region. This continuous pressure counteracts a slackening of the muscles and ligaments in the perineal area, as a result of which a sudden urge to urinate is at least reduced and more or less severe urinary incontinence of the patient can be alleviated. The natural correct position also makes it possible for the sphincter muscles to function sufficiently again. Since the pants are in the form of a woven fabric or knitted fabric produced using elastic fibers, the pants are comparatively breathable and comfortable to wear. Since the woven fabric or knitted fabric is elastic at the same time, it is capable of fitting closely against the patient's body and establishing a grip which makes it possible to apply pressure to the patient's body by means of the pressure body. In order always to ensure precise positioning of the pressure body in the desired area of the perineum, the pressure body is connected immovably to the material of the pants. The pants according to the invention can expediently be used in particular in such cases in which regular pelvic floor training does not take place or is not sufficient. In suitable cases, complex operations can also be avoided by the use of the pants according to the invention.

In order that the pressure body provided on the pants according to the invention can act with sufficient force on the user's perineal area, it is advantageous if an elastic and optionally also length-adjustable belt is threaded into the pants.

Additionally or instead, it can be advantageous if a pair of suspenders is held on the pants.

A preferred embodiment according to the invention provides here that the suspenders have two suspension straps at the front and/or rear side. Such a pair of suspenders, which have two suspension straps at the front or rear side, can approximately uniformly distribute the tensile forces of the suspension straps that act on the pants.

It is particularly advantageous if the pants are designed as underpants. A pair of pants in the form of underpants in particular can act directly on the user's perineal area by means of their pressure body.

A preferred embodiment according to the invention, which makes it possible to apply pressure directly to the user's body by means of the pressure body, provides that the pressure body is provided on the inside of the pants.

A comparatively high compressive force can be applied to the user's perineal area if the pressure body has a partial region which is in the form of a crosspiece and is raised up in the direction of a rear side of the pants. Such a pressure body, which also has a partial region that is raised up in the direction of a rear side of the pants, also acts on the perineal area with a force component which is directed upward toward the user's body.

In order that the compressive force generated is transferred to the user's perineal area in a manner as undiminished as possible, it is expedient if the pressure body is produced from a hard, hard-elastic and/or inflexible material.

In order always to ensure precise positioning of the pressure body in the desired area of the perineum is always ensured, it is advantageous if the pressure body is connected immovably to the material of the pants.

### BRIEF DESCRIPTION OF THE DRAWINGS

Developments according to the invention will become apparent from the figures in conjunction with the claims and the description. The invention is described in more detail below with reference to preferred exemplary embodiments.

In the figures:

FIG. 1 shows a side view of a pair of pants which is designed here as men's underpants and, in the region of a pants web which separates the two leg openings of the pants, has a pressure body which is intended for applying pressure to the user in the perineal area,

FIG. 2 shows the men's underpants of FIG. 1 in a partially cut-open perspective illustration,

FIG. 3 shows a side view of a pair of pants which is designed here as women's underpants and, in the region of the pants web which separates the two leg openings of the pants, likewise has a pressure body which acts on the user's perineal area, and

FIG. 4 shows the women's underpants of FIG. 3 in a partially cut-open perspective illustration.

### DETAILED DESCRIPTION

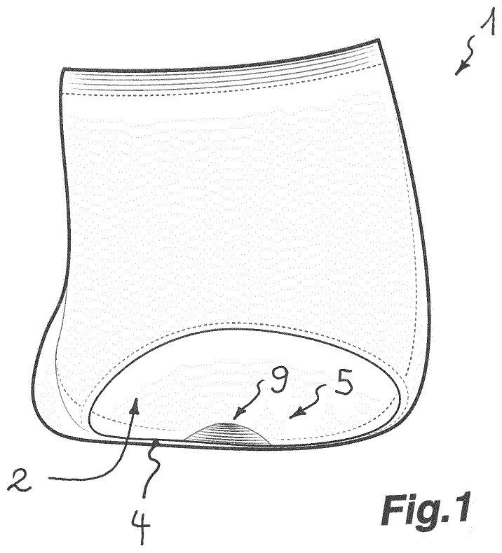

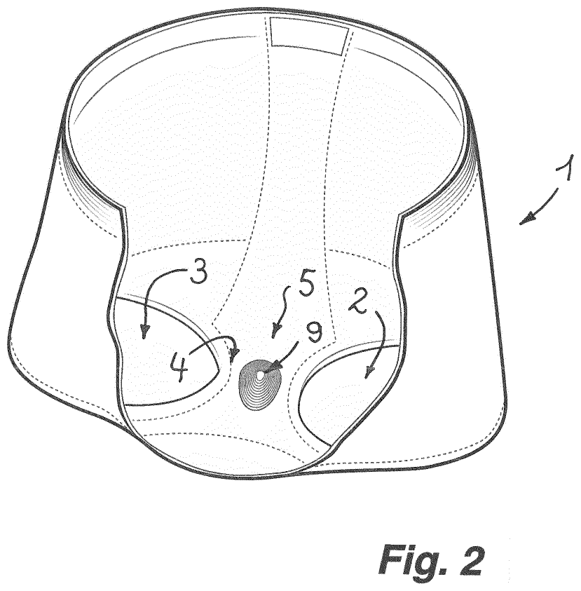

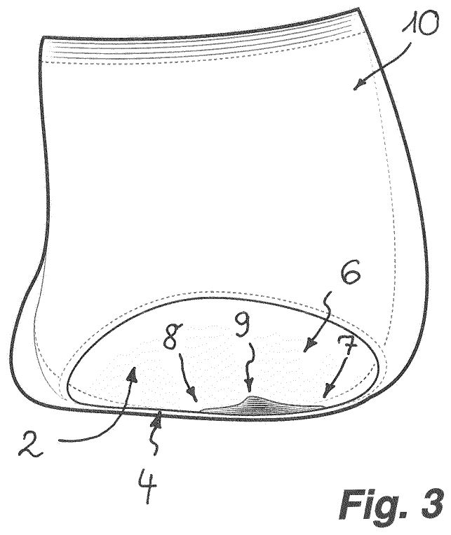

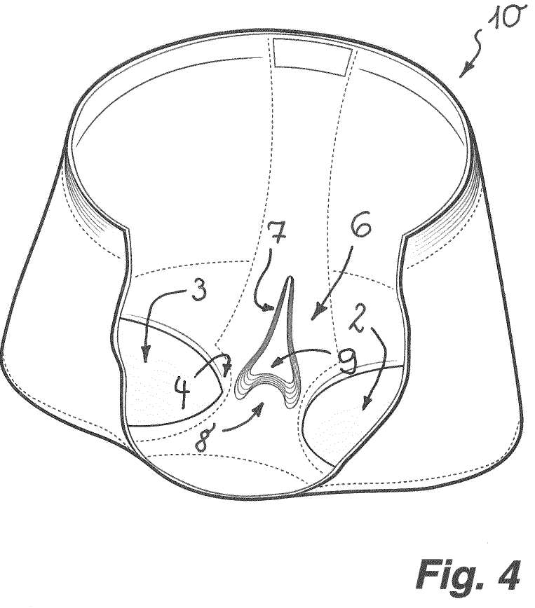

FIGS. 1 to 4 illustrate a pair of pants in two embodiments 1, 10. The pants 1, 10 have two leg openings 2, 3, which are separated from one another by a pants web 4 of the pants 1, 10. The pants 1, 10, which can be designed as long pants with legs or—such as here—can be in the form of so-called briefs without such legs, are configured here as underpants. Whereas the pants shown in FIGS. 1 and 2 are men's underpants, the pants 10 illustrated in FIGS. 3 and 4 are designed by contrast as women's underpants.

The pants 1, 10 shown in FIGS. 1 to 4 are intended for alleviating or eliminating urinary incontinence while a user is wearing the pants. For this purpose, in the region of the pants web 4 the pants have a pressure body 5 or 6 respectively which is intended for applying pressure to the user in the perineal area. This pressure body 5, 6 provided on the pants web 4 presses onto the user's body in the perineal area. This pressure boosts the user's muscles or ligaments slackened in this region and tightens the urinary tract in this region. This continuous pressure counteracts a slackening of the muscles and ligaments in the user's perineal area, as a result of which a sudden urge to urinate can be at least reduced and more or less severe incontinence of the user can be alleviated. The pants illustrated here can expediently be used in particular also in such cases in which regular pelvic floor training does not take place or is not sufficient. In suitable cases, complex operations can also be avoided by the use of the pants 1, 10.

In order that the pressure body 5, 6, which is held preferably immovably on the inside of the pants 1, 10, can act with sufficient pressure on the user's perineal area, it is advantageous if the pants 1, 10 are produced from a resiliently elastic or elastic material. An embodiment in which the pants 1, 10 are in the form of a knitted fabric produced using elastic fibers is preferred here. Such a knitted fabric is comparatively breathable and comfortable to wear. Since the woven fabric is elastic, it is capable of fitting closely against the patient's body and establishing a grip which makes it possible to apply pressure to the user's body by means of the pressure body 5, 6.

In order to promote an application of pressure that is as firm and steady as possible, it is advantageous if an elastic and optionally also length-adjustable belt has been threaded into the pants 1, 10. Additionally or instead, a pair of suspenders, although these are not shown in any more detail here, can also be held on the pants 1, 10. In order that these suspenders can uniformly distribute the forces acting on the pants 1, 10, it is advantageous if the suspenders have two suspension straps at the front and/or rear side.

In order to be able to apply the highest possible compressive force to the user's body, these pressure bodies 5, 6 are cam-shaped or approximately hemispherical at least in a crosspiece 9. With reference to the exemplary embodiment 10 shown in FIGS. 3 and 4, it is shown that the pressure body 6 can also have a crosspiece 7 which is in the form of a web and is raised up in the direction of a rear side of the pants. Since the pressure body 6 also acts on the user's perineal area with a force component which is directed toward the user's body by way of this raised-up crosspiece 7, particularly high compressive forces can be applied to the user's perineal area. In order that the compressive force generated is transferred to the patient's perineal area in a manner as undiminished as possible, the pressure body 5, 6 is produced from a hard or inflexible material. In order to ensure precise positioning of the pressure body 5, 6 in the desired area of the perineum, this pressure body 5, 6 is connected immovably to the material of the pants 1, 10. The women's underpants shown in FIGS. 3 and 4 are fork-shaped in their crosspiece 8 which faces the pubic region, wherein these fork-shaped crosspieces can be positioned to particularly good effect on either side in the area of the user's groin, where they are no longer bothersome.

### LIST OF REFERENCE SIGNS

1 Pants (according to FIGS. 1 and 2)
2 Leg opening
3 Leg opening
4 Pants web
5 Pressure body (according to FIGS. 1 and 2)
6 Pressure body (according to FIGS. 3 and 4)
7 Raised-up crosspiece (on the pressure body 6)
8 Fork-shaped crosspiece (on the pressure body 6)
9 Cam-shaped or hemispherical crosspiece
10 Pants (according to FIGS. 3 and 4)

1. A pair of pants (1, 10) with two leg openings (2, 3) which (2, 3) are separated from one another by a pants web (4) of the pants (1, 10), characterized in that the pants (1, 10) are intended for alleviating or eliminating urinary incontinence while a user is wearing the pants (1, 10), and in that, for this purpose, in the region of the pants web (4) the pants (1, 10) have a pressure body (5, 6) which is intended for applying pressure to the user in the perineal area.

2. The pants as claimed in claim 1, characterized in that the pants (1, 10) are produced from an elastic material.

3. The pants as claimed in claim 1 or 2, characterized in that the pants (1, 10) are in the form of a woven fabric or knitted fabric produced using elastic fibers.

4. The pants as claimed in one of claims 1 to 3, characterized in that an elastic and optionally also length-adjustable belt has been threaded into the pants (1, 10).

5. The pants as claimed in one of claims 1 to 4, characterized in that a pair of suspenders are held on the pants (1, 10).

6. The pants as claimed in claim 5, characterized in that the suspenders have two suspension straps at the front and/or rear side.

7. The pants as claimed in one of claims 1 to 6, characterized in that the pants (1, 10) are designed as underpants.

8. The pants as claimed in one of claims 1 to 7, characterized in that the pressure body (5, 6) is provided on the inside of the pants.

9. The pants as claimed in one of claims 1 to 8, characterized in that the pressure body (5, 6) is cam-shaped or approximately hemispherical at least in a crosspiece (9).

10. The pants as claimed in one of claims 1 to 9, characterized in that the pressure body (6) has a crosspiece (7) which is in the form of a web and is raised up in the direction of a rear side of the pants.

11. The pants as claimed in one of claims 1 to 10, characterized in that the pressure body (5, 6) is produced from a hard, hard-elastic and/or inflexible material.

12. The pants as claimed in one of claims 1 to 11, characterized in that the pressure body (5, 6) is connected immovably to the material of the pants (1, 10).
